(19) United States
(12) Patent Application Publication
(10) Pub. No.: US 2024/0121647 A1
(43) Pub. Date: Apr. 11, 2024

(54) DETECTION OF ANOMALIES IN RADIO FREQUENCY EMISSIONS

(71) Applicant: T-MOBILE INNOVATIONS LLC, Overland Park, KS (US)

(72) Inventor: Ali Daniali, Tukwila, WA (US)

(21) Appl. No.: 17/960,493

(22) Filed: Oct. 5, 2022

(51) Int. Cl. H04W 24/10; H04B 17/318; H04W 4/90

(52) U.S. Cl. CPC H04W 24/10; H04B 17/318; H04W 4/90

(57) ABSTRACT

Systems, methods, and computer-readable media herein provide for detecting anomalies in RF emissions. RF emissions may be detected within a predetermined geographical area, for example by an RF detecting device. It is determined that at least a portion of the RF emissions trigger a predetermined threshold, such as a set of rules. Based on the RF emissions triggering a predetermined threshold, an anomaly is identified in the RF emissions. An indication of the anomaly is communicated to, for example, a third party device.

### SUMMARY

The present disclosure is directed, in part, to detection of an anomaly in radio frequency (RF) emissions from devices capable of emitting RF. By way of devices operating for purposes of sending and receiving data, RF exhaust is created. Without creating any disruptions, such as privacy concerns, the RF exhaust can be used for many purposes. One such purpose is to detect whether a device is present within a certain geographical area, and in some scenarios where permission is granted, a correlation between a certain aspect of the RF exhaust and a user of the device emitting the RF exhaust. From the detected RF exhaust, an anomaly may be detected. When detected, an indication of the anomaly can be sent to a requesting party (e.g., a party with permission to obtain the information).

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, which are intended to be exemplary and non-limiting, wherein:

FIG. 1 depicts a diagram of an exemplary computing environment suitable for use in implementations of the present disclosure:

FIG. 2 depicts a diagram of detection of RF exhaust, in accordance with aspects of the present disclosure,

FIG. 3A depicts an exemplary diagram of detection of RF exhaust from a device outside of a building, in accordance with aspects of the present disclosure;

FIG. 3B depicts an exemplary diagram of detection of RF exhaust from a device inside a building, in accordance with aspects of the present disclosure;

FIG. 4 depicts a flow chart of a method for detecting anomalies in RF emissions, in accordance with aspects of the present disclosure;

FIG. 5 depicts a flow chart of another method for detecting anomalies in RF emissions, in accordance with aspects of the present disclosure; and

FIG. 6 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention.

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Aspects herein may be embodied as, among other things: a method, system, or set of instructions embodied on one or more computer-readable media. Computer-readable media include both volatile and nonvolatile media, removable and nonremovable media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random-Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 700 shown in FIG. 7. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

A“network” refers to a network comprised of wireless and wired components that provide wireless communications service coverage to one or more user equipment (UE). The network may comprise one or more base stations, one or more nodes (i.e., managed by a base station), one or more cell towers (e.g., having an antenna) associated with each base station or cell site, a gateway, a backhaul server that connects two or more base stations, a database, a power supply, sensors, and other components not discussed herein, in various embodiments.

The terms “base station,” “node” and “cell site” may be used interchangeably herein to refer to a defined wireless communications coverage area (e.g., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO (massive multiple-input/multiple-output)) as discussed herein.

The terms “user equipment,” “UE,” and/or “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, UE may take on any variety of devices, such as a personal computer, a laptop computer, a tablet, a netbook, a mobile phone, a smart phone, a personal digital assistant, a wearable device, a fitness tracker, or any other device capable of communicating using one or more resources of the network. UE may include components such as software and hardware, a processor, a memory, a display component, a power supply or power source, a speaker, a touch-input component, a keyboard, and the like. In embodiments, some of the UE discussed herein may include current UE capable of using 5G and having backward compatibility with prior access technologies (e.g., Long-Term Evolution (LTE)), current UE capable of using 5G and lacking backward compatibility with prior access technologies, and legacy UE that is not capable of using 5G.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such. Along similar lines, certain UE are described herein as being “priority” UE and non-priority UE, but it should be understood that in certain implementations UE may be distinguished from other UEs based on any other different or additional features or categorizations (e.g., computing capabilities, subscription type, and the like).

The terms “servicing” and “providing signal coverage,” “providing network coverage,” and “providing coverage,” are interchangeably used to mean any (e.g., telecommunications) service(s) being provided to user devices. Moreover, “signal strength”, “radio conditions,” “level of coverage,” and like, are interchangeably used herein to refer to a connection strength associated with a user device. For example, these terms may refer to radio conditions between a user device and a beam providing coverage to the user device. In particular, the “signal strength,” “level of coverage,” and like may be expressed in terms of synchronization signal (SS) measurements/values and/or channel state information (CSI) measurements/values. In the context of 5G, signal strength may be measured by user devices, which may communicate the signal strength to the cell site and/or the beam management system disclosed herein. In particular, a user device may report various measurements. For example, a user device may provide signal strength as certain synchronization signal (SS) measurements, such as a SS reference signal received power (SS-RSRP) value/measurement, a SS Reference Signal Received Quality (SS-RSRQ) value/measurement, a SS signal-to-noise and interference ratio (SS-SINR) value/measurement, and/or the like. Alternatively or additionally, in some embodiments, signal strength may also be measured and provided in terms of channel state information (CSI) values.

At a high level, systems, methods, and computer-readable media of the present disclosure provide for detecting anomalies in RF emissions in a predetermined geographical area, and communicating an indication of those anomalies to a receiving party who may take an action based on the anomaly. All devices with a radio and transmitter are capable of emitting RF. When those devices do emit RF (“RF exhaust”), the RF exhaust may be detected by other devices. For example, a device whose RF is being detected may be actively communicating with other devices by way of a telecommunications network, requesting information from the telecommunications network, or communicating pings to Wi-Fi routers, nodes, cell cites, small cells, etc. An RF detecting device includes at least a radio and a receiver that can, for example, detect RF emissions from other devices. In aspects, RF detecting device also includes a transmitter to transmit information to the telecommunications network.

While traditional home security systems employ cameras and other types of sensors for detecting a potential intruder on a property, connectivity issues and limitations of the sensors may cause potential intruders to be missed or otherwise not identified. Further, it may be difficult to determine who the potential intruder is with just a camera or other sensors. Aspects provided for an improved way of detecting RF emissions by utilizing an RF detecting device that is capable of detecting RF emissions, including pings from RF emitting devices. Taking into account any privacy concerns that may exist, a determination as to a potential intruder being on a property or even a determination of the identity of the potential intruder may be determined using the RF exhaust. In addition to using RF exhaust for security reasons, it may be used, for example, to monitor users of the devices, such as a child, elderly, or someone else who may need monitoring. For instance, a set of rules may be established to determine if an anomaly in the RF has occurred. Either the RF detecting device or a network component could make the determination that an anomaly has occurred. When an anomaly does occur, an indication of the anomaly can be communicated to a receiving party, such as a security system, family member, friend, etc.

In a first aspect of the present disclosure, a method for detecting anomalies in RF emissions. The method comprises detecting one or more RF emissions within a predetermined geographical area, determining that the one or more RF emissions trigger a predetermined threshold, and based on the one or more RF emissions triggering the predetermined threshold, identifying an anomaly in the one or more RF emissions. Further, the method comprises communicating an indication of the anomaly.

In a second aspect of the present disclosure. A system for detecting anomalies in RF emissions. The system comprises one or more processors and one or more computer storage hardware devices storing computer-usable instructions that, when used by the one or more processors, cause the one or more processors to perform steps. These steps comprise detecting one or more RF emissions within a predetermined geographical area, determining that the one or more RF emissions trigger a predetermined threshold, and based on the one or more RF emissions triggering the predetermined threshold, identifying an anomaly in the one or more RF emissions. Further, the steps comprise communicating an indication of the anomaly.

In a third aspect of the present disclosure, one or more computer-readable media having computer-executable instructions embodied thereon is provided such that when executed, a method is performed, the method comprising, at a detecting device, detecting one or more RF emissions from a emitting device within a predetermined geographical area, and determining that the one or more RF emissions trigger a predetermined threshold. Further, the method comprises, based on the one or more RF emissions triggering the predetermined threshold, identifying ananomaly in the one or more RF emissions and determining an identification of the emitting device. Even further, the method comprises, based on the identification of the emitting device and the identified anomaly, communicating an indication of the anomaly.

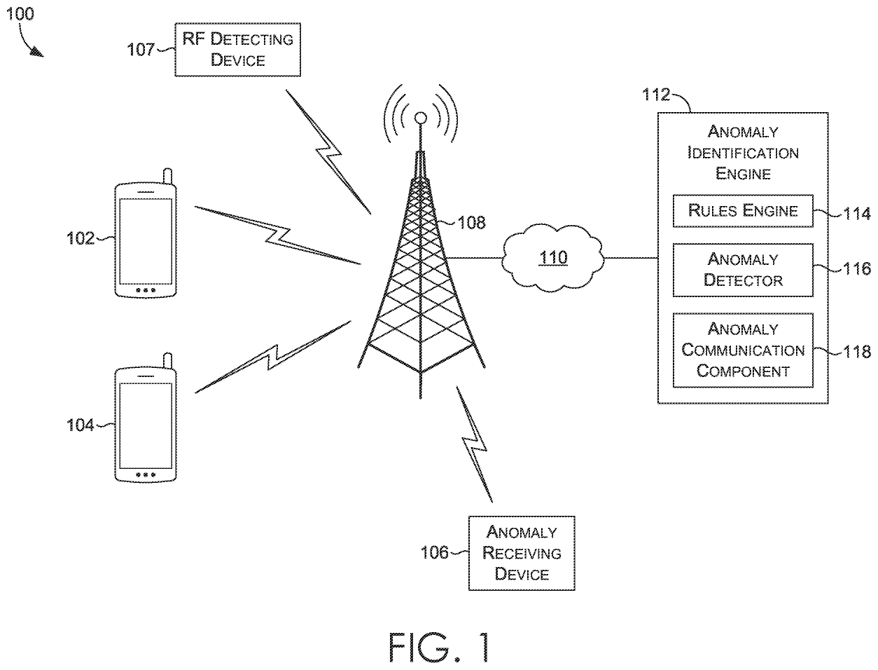

Turning to FIG. 1, an exemplary network environment is provided in which implementations of the present disclosure may be employed. Such a network environment is illustrated and designated generally as network environment 100. Network environment 100 is but one example of a suitable network environment and is not intended to suggest any limitation as to the scope of use or functionality of the invention. Neither should the network environment be interpreted as having any dependency or requirement relating to any one or combination of components illustrated.

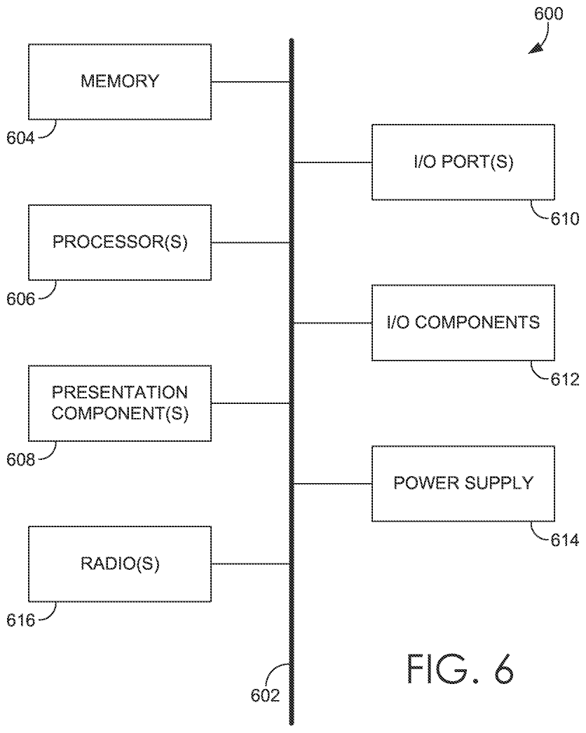

Network environment 100 provides service to one or more user devices, such as exemplary user devices 102 and 104. In some embodiments, the network environment 100 may be a telecommunication network (e.g., a telecommunication network such as, but not limited to, a wireless telecommunication network), or portion thereof. The network environment 100 may include one or more devices and components, such as base stations, servers, switches, relays, amplifiers, databases, nodes, etc. which are not shown so as to not confuse other aspects of the present disclosure. (Example components and devices are discussed below with respect to FIG. 6.) Those devices and components may provide connectivity in a variety of implementations. In addition, the network environment 100 may be utilized in a variety of manners, such as a single network, multiple networks, or as a network of networks, but, ultimately, is shown as simplified as possible to avoid the risk of confusing other aspects of the present disclosure.

The network environment 100 may include or otherwise may be accessible through node 108. Node 108 may include one or more antennas, base transmitter stations, radios, transmitter/receivers, digital signal processors, control electronics, GPS equipment, power cabinets or power supply, base stations, charging stations, and the like. In this manner, node 108 may provide a communication link between user devices 102 and 104 and any other components, systems, equipment, and/or devices of the network environment 100 (e.g., the beam management system). The base station and/or a computing device (e.g., whether local or remote) associated with the base station may manage or otherwise control the operations of components of node 108. Example components that may control the operations of components of node 108 are discussed below with respect to FIG. 6.

Node 108 may include a gNodeB, eNodeB, or any other suitable node structured to communicatively couple to user devices 102 and 104 by way of communication links. In addition to the one or more user devices (e.g., user devices 102 and 104) and RF detecting device 107, environment 100 additionally comprises anomaly receiving device 106, node 108, network 110, and anomaly identification engine 112. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a node 108 in order to interact with a public or private network.

In some aspects, the user devices 102 and 104 and RF detecting device 107 may take the form of a wireless or mobile device capable of communication via the network environment 100. For example, user devices 102 and 104 and RF detecting device 107 may take the form of a mobile device capable of communication via a telecommunication network such as, but not limited to, a wireless telecommunication network. In this regard, user devices 102 and 104 and RF detecting device 107 may be any mobile computing device that communicates by way of a network, for example, a 3G, CDMA, 4G, LTE, WiMAX, 5G, 6G or any other type of network. The network environment 100 may include any communication network providing voice and/or data service(s), such as, for example, a 1× circuit voice, a 3G network (e.g., Code Division Multiple Access (CDMA), CDMA 2000, WCDMA, Global System for Mobiles (GSM), Universal Mobile Telecommunications System (UMTS), a 4G network (LTE, Worldwide Interoperability for Microwave Access (WiMAX), High-Speed Downlink Packet Access (HSDPA)), a 5G network, or a 60 network.

In some cases, the user devices 102 and 104 and RF detecting device 107 in network environment 100 may optionally utilize network 110 to communicate with other computing devices (e.g., a mobile device(s), a server(s), a personal computer(s), etc.) through node 108. The network 110 may be a telecommunications network(s), or a portion thereof. A telecommunications network might include an array of devices or components (e.g., one or more base stations), some of which are not shown. Those devices or components may form network environments similar to what is shown in FIG. 6, and may also perform methods in accordance with the present disclosure. Components such as terminals, links, and nodes (as well as other components) may provide connectivity in various implementations. Network 110 may include multiple networks, as well as being a network of networks, but is shown in more simple form so as to not obscure other aspects of the present disclosure.

Network 110 may be part of a telecommunication network that connects subscribers to their service provider. In aspects, the service provider may be a telecommunications service provider, an internet service provider, or any other similar service provider that provides at least one of voice telecommunications and data services to any or all of the user devices 102 and 104 and RF detecting device 107. For example, network 110 may be associated with a telecommunications provider that provides services (e.g., LTE, 5G, 6G) to the user devices 102 and 104 and RF detecting device 107. Additionally or alternatively, network 110 may provide voice, SMS, and/or data services to user devices or corresponding users that are registered or subscribed to utilize the services provided by a telecommunications provider. Network 110 may comprise any communication network providing voice, SMS, and/or data service(s), using any one or more communication protocols, such as a 1× circuit voice, a 3G network (e.g., CDMA, CDMA2000, WCDMA, GSM, UMTS), a 4G network (WiMAX, LTE, HSDPA), a 5G network, or a 6G network. The network 110 may also be, in whole or in part, or have characteristics of, a self-optimizing network.

In some implementations, node 108 is configured to communicate with the user devices 102 and 104 that are located within the geographical area defined by a transmission range and/or receiving range of the radio antennas of node 108. The geographical area may be referred to as the “coverage area” of the cell site or simply the “cell,” as used interchangeably hereinafter. Node 108 may include one or more base stations, base transmitter stations, radios, antennas, antenna arrays, power amplifiers, transmitters/receivers, digital signal processors, control electronics. GPS equipment, and the like.

In aspects, user devices 102 and 104 are the devices that emit RF and whose RF is being detected by other devices, such as the RF detecting device 107. As used herein, the RF being emitted by user devices 102 and 104 is referred to herein as RF exhaust. Some RF exhaust may be used in aspects herein, and some may not. The RF detecting device 107 is responsible for detecting RF exhaust from one or more devices, such as user devices 102 and 104, and may be able to determine if an anomaly exists in the RF exhaust. In other aspects, a component on the network side determines if an anomaly exists. As used herein, an anomaly refers to something in the RF exhaust that is out of the ordinary, or that is based on one or more rules for a particular device. An anomaly could even be the existence/detection of any RF exhaust from a particular user device or from any device within a certain geographical area. In aspects, RF detecting device 107 may never actually communicate with user device 102 or 104 by way of node 108, but instead, pings from user device 102 or 104 are detected by RF detecting device 107. Therefore, communications may be unidirectional, not bidirectional.

In one exemplary aspect, an anomaly may occur when a user device, such as one of user devices 102 or 104, is emitting RF exhaust in a geographical area where that device is not supposed to be located, such as where it does not have permission to be located. For instance, the RF detecting device 107 may detect RF being emitted from user device 102. RF detecting device 107 may be located within or on a home or other building. If user device 102 approaches the home or other building and comes within a certain distance of the home or building, RF detecting device 107 may detect that user device 102 is present based on its RF exhaust. This could be a scenario in which the RF detecting device 107 is used for home or building security purposes. In this instance, anomaly communication component 118, which will be described in greater detail herein, may be used to send a notification to an owner or otherwise user of the home or building security, as an intruder or potential intruder may be in the vicinity. In these described aspects, the RF detecting device 107 may be communicatively coupled to a home security system or centralized alerting system.

In another exemplary aspect, the RF detecting device 107 may be used to detect whether or not user device 102, for example, is emitting RF. For example, if user device 102 has been turned off or has run out of batteries, user device 102 would no longer be emitting RF. Here, a rules engine 114, which will be discussed in greater detail herein, may be consulted to determine if an anomaly has occurred. For instance, user device 102 may belong to a person's grandmother who is living on her own or in a retirement home. The person may have had RF detecting device 107 installed with grandmother's permission. In the case where RF detecting device 107 does not detect any RF being emitted either from user device 102 or from any device within a certain geographical area, an anomaly may be detected. The anomaly communication component 118, which will be discussed in greater detail herein, may be used to send out a notification to the person, or anomaly receiving device 106, that RF is not being detected from user device 102. This could act as a security measure to ensure grandmother doing well, as if an anomaly is detected, the person may want to call or otherwise check up on grandmother.

As shown, node 108 is in communication with anomaly identification engine 112. Generally, the anomaly identification engine 112 is responsible for identifying anomalies in the RF exhaust that is being detected by a device. The anomaly identification engine 112 comprises a rules engine 114, an anomaly detector 116, and an anomaly communication component 118. The rules engine 114 may include one or more rules for a particular user/customer that indicates when an anomaly should be identified. When an anomaly is identified by anomaly detector 116 based, for instance, on the rules in rules engine 114, other actions may be triggered, such as a notification to be sent to the user/customer, shown as anomaly receiving device 106. Rules engine 114 may, in one aspect, include rules for a particular user associated with RF detecting device 107 based on RF exhaust of user device 102 and/or 104. The rules could be an expected pattern of RF, and if the RF exhaust indicates that the expected pattern has not occurred, an anomaly may be detected. For instance, and as described above, grandmother's device may have rules associated with it that if grandmother's device is turned off (e.g., no RF emissions detected) for a predetermined amount of time (e.g., 1 hour, 2 hours, 5 hours), an anomaly has occurred. Or, rules engine 114 may include rules associated with it that if any RF emissions are detected within a predetermined distance of a home (e.g., indicating a security threat to the home), an anomaly has occurred. The rules engine 114 may be preset with device identifiers that are considered safe, such that RF emissions are detected from any device that is not one considered to be safe, an anomaly has occurred.

In other aspects, various frequencies may be detected by using the RF exhaust. RF detecting device 107 may have software installed that is able to discern a frequency being received, emitted, or otherwise used by user device 102 or 104. For instance, using the example with grandmother, grandmother may listen to FM radio at a particular time of day. If RF detecting device 107 does not detect this from grandmother's device, an anomaly may have occurred.

Having described the network environment 100 and components operating therein, it will be understood by a person having ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by a person having ordinary skill in the art that the number, interactions, and physical location of components illustrated in FIG. 1 are examples, as other methods, hardware, software, components, and devices for establishing one or more communication links between the various components may be utilized in implementations of the present disclosure. It will be understood to a person having ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

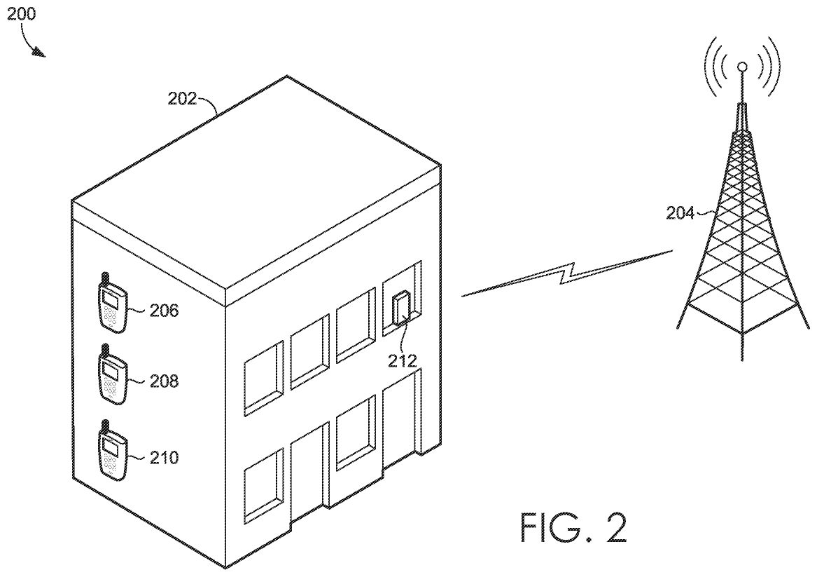

Turning now to FIG. 2, a diagram is provided of detection of RF exhaust, in accordance with aspects of the present disclosure. In environment 200, a building 202 comprises, at least, an RF detecting device 212 and user devices 206, 208, and 210. User devices 206, 208, and 210 and RF detecting device 212 may communicate with a telecommunications network by way of node 204 (telecommunications network not shown in FIG. 2 for purposes of brevity). RF detecting device 212 may detect RF emissions from one or more of user devices 206, 208, and 210. In aspects herein, user devices 206, 208, and 210 and RF detecting device 212 may be located either inside, outside, or on building 202.

In some aspects, RF detecting device 212 may detect RF emissions in an agnostic way, so as not to know the identity of the device emitting the RF. But, in other aspects, RF detecting device 212 may know, or may be able to determine, an identify of the user device or even a user associated with the user device that is emitting RF detected by RF detecting device 212. For instance, RF detecting device 212 may only be wanting to detect RF emissions from user device 206, but if the other user devices in the area are also emitting RF, RF detecting device 212 (or a network component) may need to have the ability to filter out only RF emissions from user device 206.

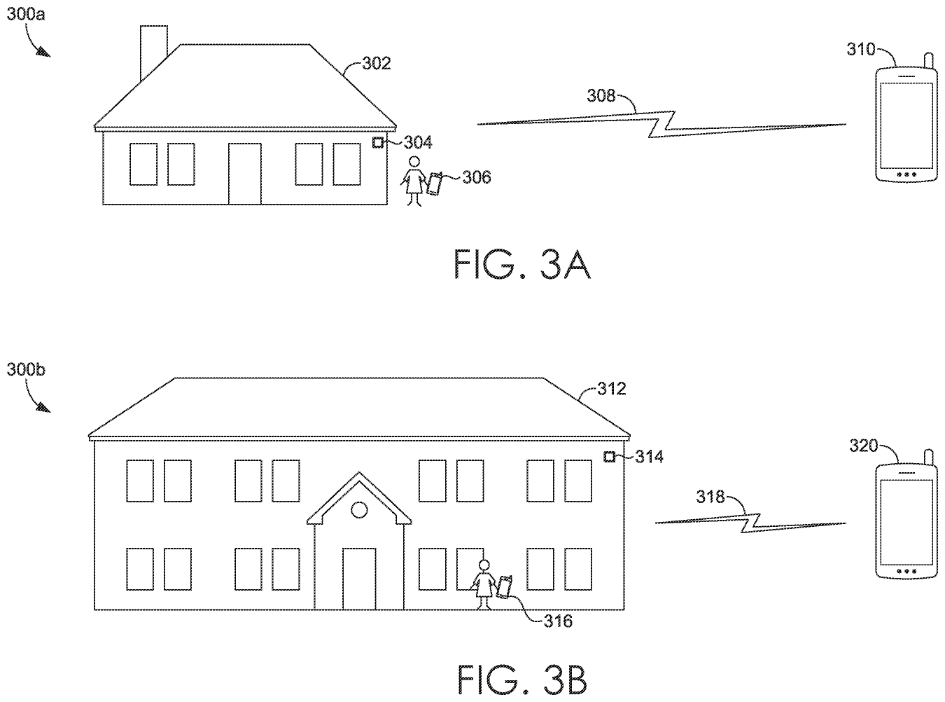

FIG. 3A depicts an exemplary diagram of detection of RF exhaust from a device outside of a building, in accordance with aspects of the present disclosure. Environment 300a comprises a building 302, an RF detecting device 304, a user device 306, communication link 308, and a third party device 310. A telecommunications network and node are not shown in FIG. 3A for the purposes of brevity. Here, RF detecting device 304 could be located inside, outside, or on building 302. User device 306, in the aspect of FIG. 3A, is located outside of building 302. For example, a user corresponding to user device 306 may not have permission to enter or even be near building 302. RF detecting device 304 may detect RF emissions from user device 306 as soon as user device 306 has come within a predetermined distance from either building 302 or RF detecting device 304. RF detecting device 304 may have the capability of determining whether an anomaly exists in the RF exhaust, or may rely on a network component (e.g., anomaly identification engine 112 of FIG. 1). When an anomaly exists, and indication of the anomaly may be sent to third party device 310 by way of communication link 308. Third party device 310 could be any type of device described with respect to FIG. 6, such as, for example, a user device or a home security system that could trigger the authorities as to a potential intruder.

FIG. 3B depicts an exemplary diagram of detection of RF exhaust from a device inside a building, in accordance with aspects of the present disclosure. Environment 300b comprises a building 312, an RF detecting device 314, a user device 316, communication link 318, and third party device 320. In this aspect, user device 316 may be located within building 312. As such, in one aspect, user device 316 may be allowed to be in building 312, but RF detecting device 314 may be used to detect RF exhaust not for security purposes, but more likely for purposes of ensuring that a user associated with user device 316, for example, is following consistent patterns. For instance, here, user device 316, while continually emitting RF while the device is turned on, would discontinue emitting RF when the device has been turned off or has run out of batteries. A rules engine may be utilized by either RF detecting device 314 or a network component (e.g., rules engine 114 of FIG. 1) to determine when an anomaly associated with the RF exhaust exists, such as when a pattern of RF behavior is discontinued (e.g., no RF emitted for more than a certain period of time). For exemplary purposes only and not limitation, aspects of FIG. 3B could be used in an independent living community or some other home or facility where a person within (or even outside) the building may need to be monitored. If an anomaly is determined to exist, an indication of the anomaly may be communicated to third party device 320 by way of communication link 318. Third party device 320 could be any type of device, and may be associated with a person who is a relative, parent, friend, or the like to user device 316.

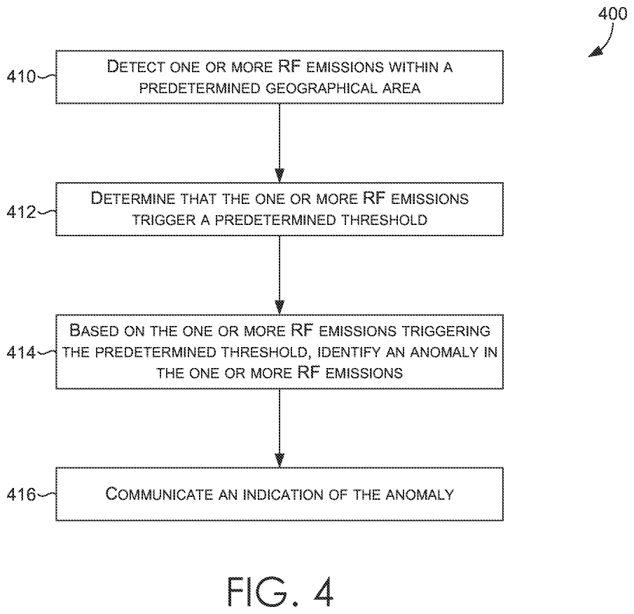

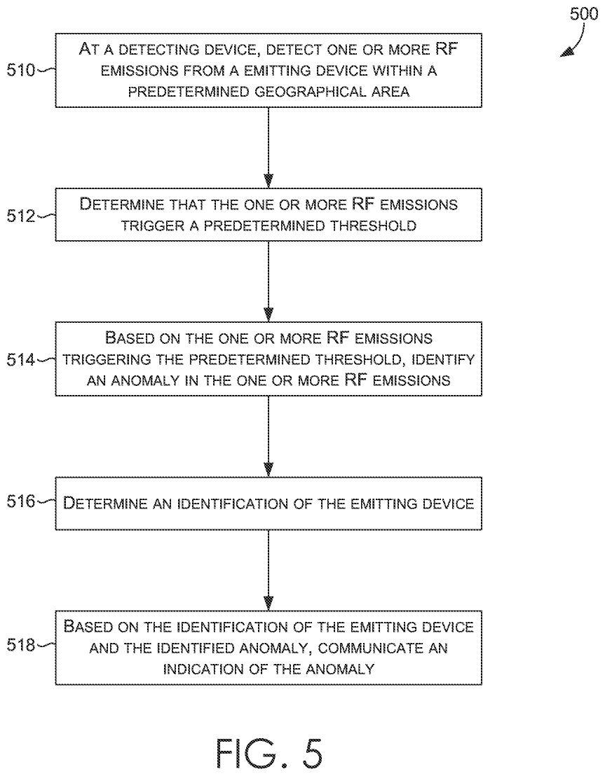

Now referring to FIGS. 4-5, each block of methods 400 and 500, described herein, comprises a computing process that may be performed using any combination of hardware, firmware, and/or software. For instance, various functions may be carried out by a processor executing instructions stored in memory. The methods 400 and 500 may also be embodied as computer-usable instructions stored on computer storage media. The methods 400 and 500 may be provided by a standalone application, a service or hosted service (standalone or in combination with another hosted service), or a plug-in to another product, to name a few. In addition, the methods 400 and 500 are described, by way of example, with respect to the system of FIG. 1. However, these methods may additionally or alternatively be executed by any one system, or any combination of systems, including, but not limited to, those described herein.

FIG. 4 depicts a flow chart of a method 400 for detecting anomalies in RF emissions, in accordance with aspects of the present disclosure. At block 410, one or more RF emissions are detected within a predetermined geographical area. In aspects, an indication may be received of a user device associated with the RF emissions. This could be a single user device, or multiple user devices. Based on the identification of the user device, an identity of a user associated with the user device may also be determined. At block 412, it is determined that the RF emissions trigger a predetermined threshold. The predetermined threshold may comprise, for instance, a set of rules established by a monitoring party. As mentioned above, these rules could be a pattern of RF emissions for a particular user device. Or, the predetermined threshold may comprise an absence of an expected spectrum range of RF detected in the RF emissions. The absence of the expected spectrum range of RF may be over a predetermined period of time. At block 414, based on the RF emissions triggering a predetermined threshold, an anomaly is identified in the RF emissions. At block 416, an indication of the anomaly is communicated to, for instance a third party device. In one instance, the indication of the anomaly may be communicated to emergency personal, or some other person based on the type of RF emissions being detected. For example, the indication of the anomaly may be communicated to a monitoring party that is monitoring RF emissions for anomalies. In aspects herein, the RF detecting device may not transmit any communications to the devices emitting RF emissions (devices whose RF emissions are being detected). Thus the communication between the devices emitting RF that is being detected and the RF detecting device may be unidirectional, as opposed to bidirectional.

FIG. 5 depicts another flow chart of a method 500 for detecting anomalies in RF emissions, in accordance with aspects of the present disclosure. At block 510, at a detecting device, RF emissions are detected from an emitting device within a predetermined geographical area. While the detecting device detects RF emissions from emitting devices, the communication between the two or more devices may be unilateral, but not bilateral. In other words, the emitting device may not communicate directly or communicate signaling or messages to the emitting devices. At block 512, it is determined that the RF emissions trigger a predetermined threshold. At block 514, based on the RF emissions triggering the predetermined threshold, an anomaly is detected. At block 516, an identification of the emitting device is determined. This identification could be made at the RF detecting device, or could be made by a network component, Even further, an identification of a user associated with the emitting device may be determined. At block 518, based on the identification of the emitting device and the identified anomaly, an indication of the anomaly is communicated. The anomaly may be communicated to a security system, or may be communicated to an individual or group of individuals.

Referring now to FIG. 6, a diagram is depicted of an exemplary computing environment suitable for use in implementations of the present disclosure. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 602 that directly or indirectly couples the following devices: memory 604, one or more processors 606, one or more presentation components 608, input/output (I/O) ports 610. I/O components 612, power supply 614 and radio(s) 616. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component, such as a display device to be one of I/O components 612. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 604 includes computer-storage media in the form of volatile and/or nonvolatile memory. Memory 604 may be removable, non-removable, or a combination thereof. Exemplary memory includes solid-state memory, hard drives, optical-disc drives, etc. Computing device 600 includes one or more processors 606 that read data from various entities, such as bus 602, memory 604, or I/O components 612. One or more presentation components 608 presents data indications to a person or other device. Exemplary one or more presentation components 608 include a display device, speaker, printing component, vibrating component, etc. I/O ports 610 allow computing device 600 to be logically coupled to other devices, including I/O components 612, some of which may be built in computing device 600. Illustrative I/O components 612 include a microphone, joystick, game pad, satellite dish, scanner, printer, wireless device, etc.

Radio(s) 616 represents a radio that facilitates communication with a wireless telecommunications network. Illustrative wireless telecommunications technologies include CDMA, GPRS. TDMA, GSM, and the like. Radio 616 might additionally or alternatively facilitate other types of wireless communications including Wi-Fi, WiMAX. LTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method for detecting anomalies in RF emissions, the method comprising:
detecting one or more RF emissions within a predetermined geographical area;
determining that the one or more RF emissions trigger a predetermined threshold;
based on the one or more RF emissions triggering the predetermined threshold, identifying an anomaly in the one or more RF emissions; and
communicating an indication of the anomaly.

2. The method of claim 1, further comprising receiving an identification of a user device associated with the at least one of the one or more RF emissions.

3. The method of claim 2, further comprising based on the identification of the user device, determining an identity of a user associated with the user device.

4. The method of claim 1, wherein the one or more RF emissions are produced by one or more user devices.

5. The method of claim 1, wherein the predetermined threshold comprises one or more rules established by a monitoring party.

6. The method of claim 1, wherein the predetermined threshold comprises an absence of an expected spectrum range of RF detected in the one or more RF emissions.

7. The method of claim 6, wherein the absence of the expected spectrum range of RF is over a predetermined period of time.

8. The method of claim 1, wherein the indication of the anomaly is communicated to emergency personnel.

9. The method of claim 1, wherein the indication of the anomaly is communicated to a monitoring party that is monitoring the one or more RF emissions for anomalies.

10. The method of claim 1, wherein the detecting the one or more RF emissions comprises a unidirectional communication between a first device emitting RF and a second device detecting the RF being emitted by the first device.

11. The method of claim 10, wherein the second device that is detecting the RF being emitted by the first device comprises a transmitter and a receiver.

12. The method of claim 11, wherein the second device that is detecting the RF being emitted by the first device does not transmit any communications to the first device.

13. A system for detecting anomalies in RF emissions, the system comprising:
one or more processors; and
one or more computer storage hardware devices storing computer-usable instructions that, when used by the one or more processors, cause the one or more processors to:
detect one or more RF emissions within a predetermined geographical area;
determine that the one or more RF emissions trigger a predetermined threshold;
based on the one or more RF emissions triggering the predetermined threshold, identify an anomaly in the one or more RF emissions; and
communicate an indication of the anomaly.

14. The system of claim 13, wherein the predetermined threshold comprises one or more rules established by a monitoring party.

15. The system of claim 13, wherein the predetermined threshold comprises an absence of an expected spectrum range of RF detected in the one or more RF emissions.

16. The system of claim 15, wherein the absence of the expected spectrum range of RF is over a predetermined period of time.

17. The system of claim 13, wherein the detecting the one or more RF emissions comprises a unidirectional communication between a first device emitting RF and a second device detecting the RF being emitted by the first device.

18. The system of claim 17, wherein the second device that is detecting the RF being emitted by the first device does not transmit any communications to the first device.

19. One or more computer-readable media having computer-executable instructions embodied thereon that, when executed, perform a method comprising:
at a detecting device, detecting one or more RF emissions from a emitting device within a predetermined geographical area;
determining that the one or more RF emissions trigger a predetermined threshold;
based on the one or more RF emissions triggering the predetermined threshold, identifying an anomaly in the one or more RF emissions;
determining an identification of the emitting device; and
based on the identification of the emitting device and the identified anomaly, communicating an indication of the anomaly.

20. The one or more computer-readable media of claim 19, wherein the detecting device that is detecting the RF being emitted by the emitting device does not transmit any communications to the emitting device.
